(19) United States
(12) Patent Application Publication
(10) Pub. No.: US 2009/0287524 A1
(43) Pub. Date: Nov. 19, 2009

(54) Method for offering the user through a web portal a project to be financed by means of credits accumulated with the purchase over Internet in properly selected e-commerce sites

(76) Inventor: Simone Gnoato, Rosa' (Vicenza) (IT)

Correspondence Address: HEDMAN & COSTIGAN P.C., 1185 AVENUE OF THE AMERICAS, NEW YORK, NY, 10036, US

(21) Appl. No.: 12/383,839

(22) Filed: Mar. 26, 2009

Related U.S. Application Data
(60) Provisional application No. 61/072,193, filed on Mar. 28, 2008.

(51) Int. Cl. G06Q 40/00; G06Q 20/00; G06Q 10/00; G06Q 30/00

(52) U.S. Cl. 705/8; 705/35; 705/39; 705/14.16; 705/7; 705/26

(57) ABSTRACT

A method by which various stakeholders may interact in order to allocate money funds to certain determined projects through a web portal to a project to be financed by means of credits accumulated with purchases over the Internet in selected e-commerce sites by web users who purchase or want to hand over sums of money, to users who offer projects to be financed through a portal which manages the transactions. The invention also includes a method for offering, through a web portal, projects to be financed by means of credits which accumulate as a result of purchases over the Internet that can offer wide guarantees to the donee that the proposed projects have considerable potential to collect cash funds which will allow the implementation of the proposed projects.

This application claims the priority of Provisional Application Ser. No. 61/072,193, filed Mar. 28, 2008.

The present invention relates to a method for offering the user, through a web portal, a project to be financed by means of credits accumulated with the purchase over Internet in properly selected e-commerce sites and directly in the web portal.

More particularly, the invention concerns fundraising and donations which web users can do, for example by accumulating credits with e-commerce transactions.

Internet world offers countless ways to earn money.

Often, however, there is the problem of reliability of the person who intends to fundraise; effective and accurate feedback of the use of the collected money also lacks, therefore, often, the user of the web has difficulty in assessing the credentials of the person to whom a donation is made.

Moreover, a system of rules and feedback which obliges the applicant group to clearly explain the projects and demonstrate its ability to make good use of the collected money is lacking.

It would be important, then, that the user has a history of the projects previously offered by the group applying for the funding because this can help to evaluate the reliability thereof.

Often, the various offered projects (even and mostly those ones involving charitable works) are not in competition each other, because some criteria for comparing them aren't clear; in that case, the competition, such as that one existing in the free market, would lead to a more efficient use of collected money.

Finally, many times the collected money is not sufficient to complete the project for which funds are collected; it so happens that the web users finance partially many projects, but among these only a few are brought to an end.

Furthermore, in order to encourage competition, it would be desirable to create a web portal where all the projects can be compared each other and that, if possible, takes charge of collecting money which then the web users can allot to the project, thus also favouring collaboration with companies that operate with the e-commerce and not world; as well as it would be desirable to exploit the potential which a web portal dedicated to non-profit associations can have in terms of publicity for the associated e-commerce websites, which, therefore, saving marketing, could be able to hand over much more money.

Purpose of the present invention is therefore to indicate a method to make various stakeholders interacting in order to allocate money funds to certain determined projects and, in particular, to indicate a method for offering, through a web portal, a project to be financed by means of credits which can be accumulated with purchases over Internet in properly selected e-commerce sites, according to rules and methods that aim to simultaneously maximize the advantages of all the actors which intervene in these transactions, that is the web users who purchase or want to hand over sums of money, through Internet, the users who offer projects to be financed and the portal which manages all the transactions and any partner websites.

Other purpose of the invention is to indicate a method for offering, through a web portal, a project to be financed by means of credits which can be accumulated with purchases over Internet in properly selected e-commerce sites which can offer wide guarantees to the donor user that the proposed projects, in which he/she has locked up and handed over credits, have considerable possibilities to collect all the cash funds which will allow their implementation.

These and other purposes are achieved by a method for offering, through a web portal, a project to be financed by means of credits accumulated with purchases over Internet in properly selected e-commerce sites, according to the appended claim 1.

Other technical features of detail of the method are present in the dependent claims.

Advantageously, thanks to such a method, the donor user can manage the accumulated credits with some precise rules, deciding when and on which project locking up his/her credits and checking the credentials of the receiving user and the implementation of the offered project.

The control of the progress of the offered project offers the donor user the possibility to eventually change the destination of the credits previously locked up in projects considered most important and worthy.

Moreover, the method allows the receiving user to change the individual sums of the project objectives, in order to take account of possible funds collected by the receiving user from other sources.

Finally, the method considers the reliability of the receiving user, who offers the project, when the real sum of the single project objectives is converted into credits which are managed through the logic of allocation of the web portal that manages transactions, profiles of all the users and projects.

Further advantages will be more evident from the description that follows, referred to a specific and illustrative, but not limiting, embodiment of the method for offering, through a web portal, a project to be financed by means of credits accumulated with purchases over Internet in properly selected e-commerce sites, in accordance with the present invention, and the attached drawings, in which:

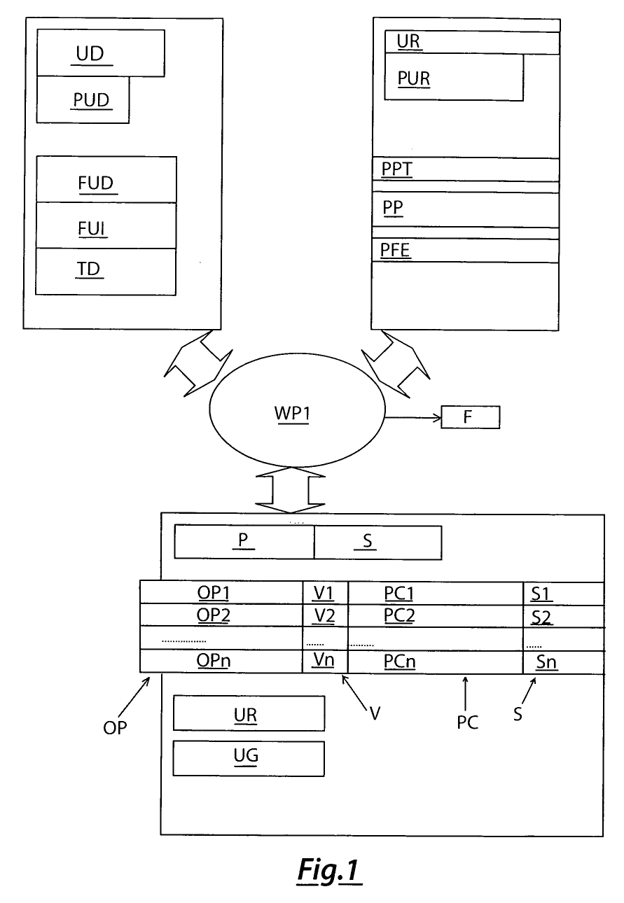

FIG. 1 shows a preliminary block diagram of the method for offering, through a web portal, a project to be financed by means of credits accumulated with purchases over Internet in properly selected e-commerce sites, according to the present invention;

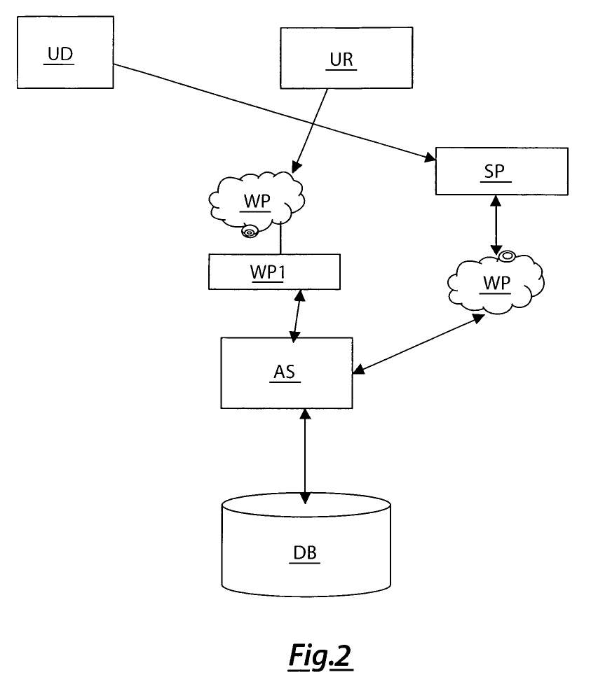

FIG. 2 shows a possible hardware and software architecture necessary to implement the method for offering, through a web portal, a project to be financed by means of credits accumulated with purchases over Internet in properly selected e-commerce sites, according to the present invention;

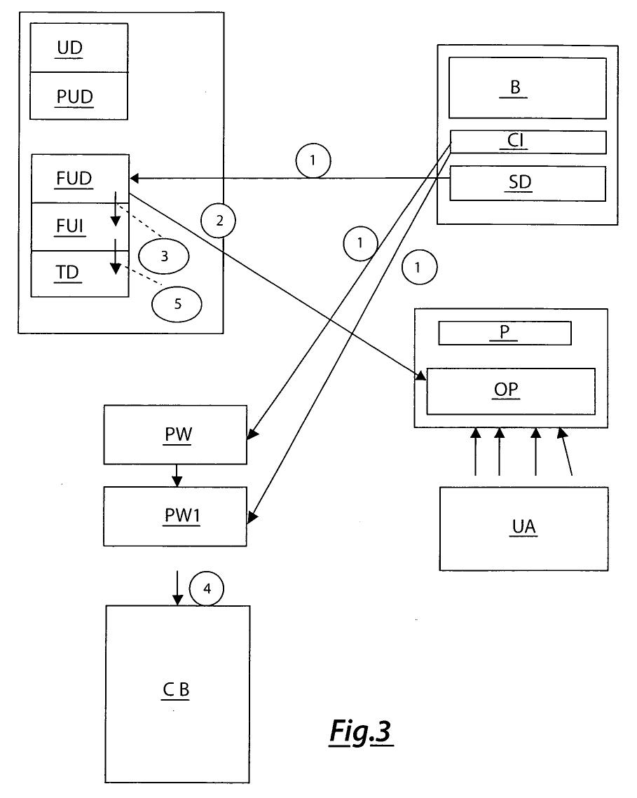

FIGS. 3, 4, 5A, 5B and 6 show as many preliminary block diagrams illustrating some phases of the method for offering, through a web portal, a project to be financed by means of credits accumulated with purchases over Internet in properly selected e-ecommerce sites, according to the present invention.

With particular reference to the mentioned FIG. 1, the donor user/s is indicated with UD, the receiving user/s with UR, the project implemented among the offered projects PP with P, the objective/s of the project/s with OP, the fund locked up by the donor user UD with FUI, the available user fund with FUD, the donated total sum of money with TD, the web portal which manages the transactions, user profiles and projects with WP1, a reserve fund at web portal WP1 manager's disposal with F.

In addition, it is defined as credit the unit of measure which is used in the web portal WP1 to quantify and give value to the funds accumulated by donor users UD, as well as to give value to some objects that can be sold and/or bought in the web portal WP1 and/or affiliated websites.

The donor user/s UD can be any person, provided with user profile PUD, to which he/she can access with login and password.

User profile PUD might contain the following fields:
nickname of the user;
data relating to user, which can be drawn up at donor user's UD discretion;
available user fund FUD, which represents the amount of credits which the donor user UD has accumulated through transactions over Internet and according to certain rules that are part of the present invention;
locked up available donor user FUI, which represents the amount of credits already locked up to project objectives OP offered by the receiving users UR (the credits of the fund FUI are locked up in project objectives OP, but their commitment by the donor user UD has not yet resulted in a physical money flow in favour of the project objectives OP and the donor user UD has still the ability to change the destination of these credits according to time and rules that are part of the invention);
credits which have already given a money flow in favour of the project objectives OP chosen by the donor user UD (generically indicated as the donated total sum TD).

Furthermore, all types of funds may be divided by category (for example, locked up donor user fund FUI can be divided into fund FUI of cat. A, fund FUI of cat. b, etc., depending on the weight the donor user UD allots to his/her own resources).

In this way, directly from his/her user profile PUD the donor user UD has the opportunity to browse through the web portal WP1, see the history of his/her actions and also see the trend of the fundraising by the offered projects PP where the donor user UD has locked up some credits.

Similarly, the receiving user UR (physical person and/or association) offers projects for which is looking for funding, creating his/her profile PUR in the web portal WP1, which will also contain a range of useful information for the evaluation of the various receiving users UR by the donor users UD.

In particular, information referred to projects PPT previously carried out, information related to projects PFE under implementation and those ones related to projects P under funds collection are associated with the receiving user UR.

Moreover, the receiving user UR could also be a guarantor subject for someone else; specifically, in case a person stands surety (guarantor user UG) for another user, the latter inherits some guarantor user UG features in order to increase his/her level of credibility at donor user's UD eyes who is interested in his/her offered project PP.

Finally, among the offered projects PP, the project P for which the receiving user UR fundraises presents a number of project objectives OP1, OP2, . . . , OPn, each with their amount of credits V1, V2, . . . , Vn, which give a measure of the funds needed to carry it out.

For each project objective OP is also reported the state S1, S2, . . . , Sn (S) of its project P, which indicates to the donor user UD if the corresponding objective OP is in fundraising phase, in development phase or implemented.

For each single project objective OP is also possible to know how, when and by whom credits and percentage PC1, PC2, . . . , PCn (PC) covered by locked up funds FUI have been allotted.

As already reminded, each project P can have, besides a receiving user UR, a guarantor user UG.

Attached FIG. 2 shows a possible hardware and software architecture for the implementation of the method in accordance with the present invention.

In particular, the donor user UD, through his/her PC, can connect with Internet WP, accessing the portal or website WP1, where he/she can manage his/her transactions.

The hardware structure also comprises some application servers AS and some database servers DB, which can also be physically located in different places.

It is also provided that the donor user UD can connect himself with another partner website SP, which gains access to the application server AS, in such a way as to enable donor user UD to directly login into the partner website SP.

Thus, when the donor user UD purchases a good in the partner website SP (having directly logged into the partner website SP), his/her profile PUD is automatically updated, possibly updating the amount of earned credits.

In this respect, the invention provides that the value of each credit is function of the receiving user UR who offers the project P; this means that if two different receiving users UR offer two projects P and two respective project objectives OP which require the same real sum of money to carry them out, it is possible that two different amounts of credits are allotted to these two projects P.

In particular, the rule which is followed is that the more reliable is a receiving user UR the lower will be the amount of credits into which the real sum of money will be converted.

The reliability of a receiving user UR is represented by some parameters, which can be automatically generated or can be entered by those who manage the web portal WP1 as feature of a specific receiving user UR.

The value of the credits for a determined receiving user UR is in any case a function increasing proportionally with the number of projects carried out and decreasing proportionally with the number of projects not carried out and might also be a function of a parameter which can be changed by those who manages the web portal WP1 and derived from the evaluation of all the donor users UD who have locked up or not their credits in the project P.

In summary, the value of a credit which is allotted to receiving user's UR project P can be calculated as follows:

c=K*Cr

where K is a reliability function and Cr is a reference value decided by those who manages the web portal WP1. In particular, K is a function of the type f(X, Y, W), with X equal to the number of projects P carried out, Y equal to the number of projects not carried out and W consists in the parameter derived from the evaluation of all the donor users UD who have locked up or not their credits in the project P; furthermore:

δf/dx≧0

δf/dy≦0

δf/dw≧0

for X, Y, W ranging from −99999 to 99999, δf/dx meaning the first derivative function of the function “f” with respect to the variable X.

The type of function “f” to be used depends on the weight given to the single parameters.

In case, then, the project P among those ones PP offered uses a guarantor user UG, the value “c” allotted to the credit is calculated with guarantor user's UG function K.

Furthermore, the number of credits which are allotted to the single project objective OP also depends on the number of objectives OP which distinguish the project P.

This can be taken into debit account by defining a new variable “q”, function of the number “n” of project P:

q=f(n)

with δf/dn≧0 and, in particular, δf/dn=0 for values of “n” greater than Z (n>Z), where Z is a data chosen by those who manages the web portal WP1.

The real amount or amounts the receiving user UR allots to each project objective OP cannot also be smaller than a certain percentage of the total sum TP of the project P (i.e., i/TP>j, where j is a parameter decided by those who manages the web portal WP1).

Under these conditions, credits equal to i/(c*q) will be allotted to the project objective OP, with the sum “i” which may be subject to a maximum limit L (also managed by those who manage the web portal WP1).

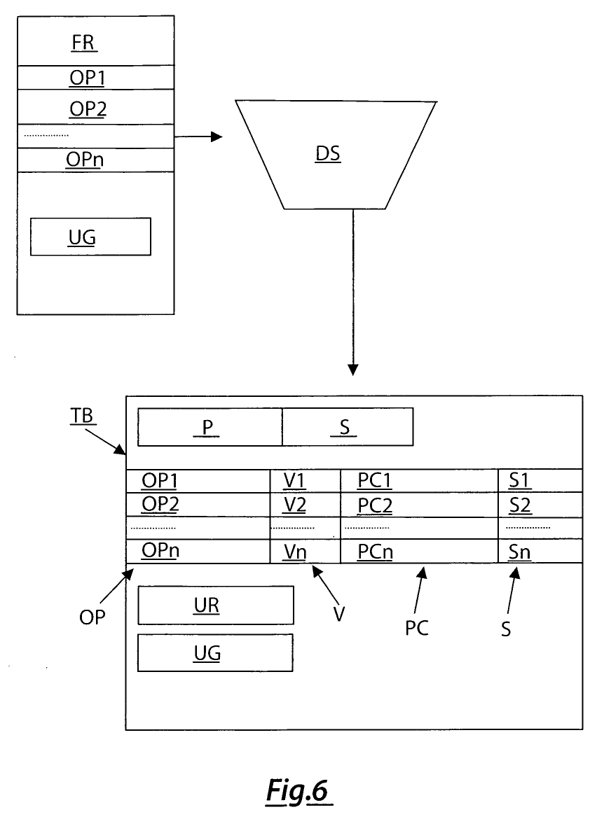

Then, the receiving user UR, once identified the number of objectives OP1, OP2, . . . , OPn, with the relative sums “i”, reports them in a request form FR of admission and/or publication of the project P (as clearly illustrated in the appended FIG. 6); at this stage, yet nothing is visible to the other users of the web portal WP1.

When the web portal WP1 processes the request, through the computer DS which acts on its own database server DB, gives a table TB, which is published on the web portal WP1, with the amount of credits allocated to the single project objectives OP according to the rules above mentioned; at this point, the project P is visible and the donor users UD may begin locking up their credits.

In alternative embodiments, it is also possible to provide a preliminary phase according to which it is possible to promise credits to projects P without actually purchasing such credits, so that, at this preliminary phase, both the donor user/s UD and the receiving user/s UR take an idea of the potentialities of the project P.

Credits accumulate when a donor user UD purchases a for sale good B on the web portal WP1 or on a partner website SP; therefore, anything that allows credits accumulation, through such a purchase, is distinguished by a total price or cost CT and by a certain amount of credits associated with it.

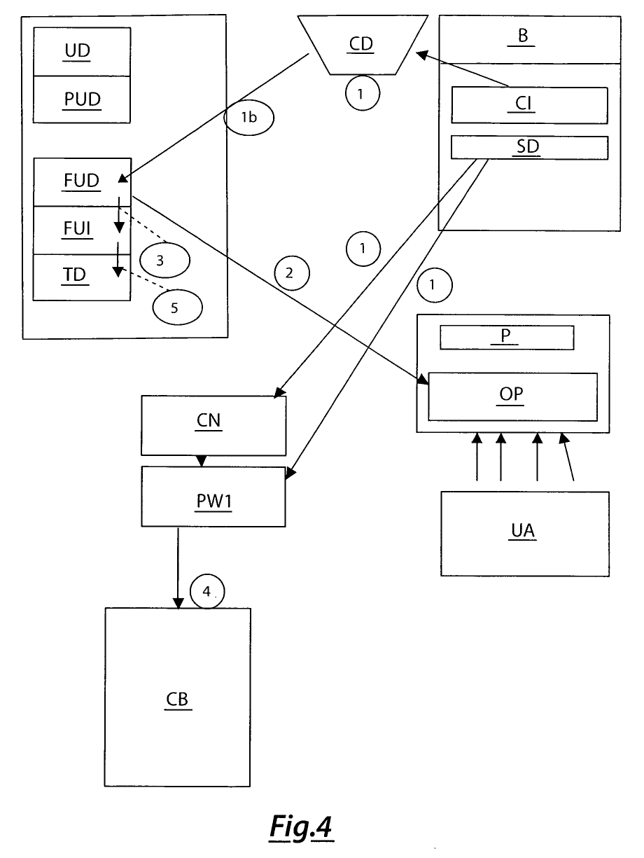

In the database server DB at the base of web portal WP1, for each article or good B to be purchased on the partner website SP, is reported the total cost CT of the article or articles purchased, the number of credits associated with this and the sum of money SD which the partner website must hand over to the web portal WP1, sum which will be partly used to finance the various project objectives OP (as seen from the attached FIGS. 3 and 4, arrows 1 and 2).

Also in this case, it is noted that if two goods B have equal cost CT they can have two different amounts of credits associated with them.

The donor user UD will see, therefore, at the purchase moment, a dual assessment of the purchased good B, that is its real price, which represents the sum of money which the user UD must actually pay, and the number of credits associated with it, which represents the ability to finance project objectives OP offered in the web portal WP1 (expressed in the conventional measure unit “credit”).

It is so proposed a dual assessment of the good B using two different reference systems.

As shown in the mentioned FIGS. 3 and 4, the moment of purchase generates three flows (arrows indicated with 1): a first flow of money towards the current account PW of the partner website WP, a second flow of money into the current account PW1 of the web portal WP1 and a virtual flow of credits which increases the amount of credits to be locked up of the receiving user UR who has carried out the purchase.

It is also provided the possibility to purchase the good B in a real shop or in affiliate e-commerce websites; in this case, the dealer will deliver to the buyer a code CD, which refers to the purchased good B, offering the donor user UD the opportunity to receive credits related to the product bought in his/her profile.

For each product or good B a relative identification code, with which a certain amount of credits is associated, will then be saved in the database DB and the accumulation of credits will occur in the web portal WP1 through a flow of credits (arrow 1b of FIG. 4) generated by the receiving users UR and sent towards the available funds to be locked up FUD (procedure known as “credits accumulation by code”).

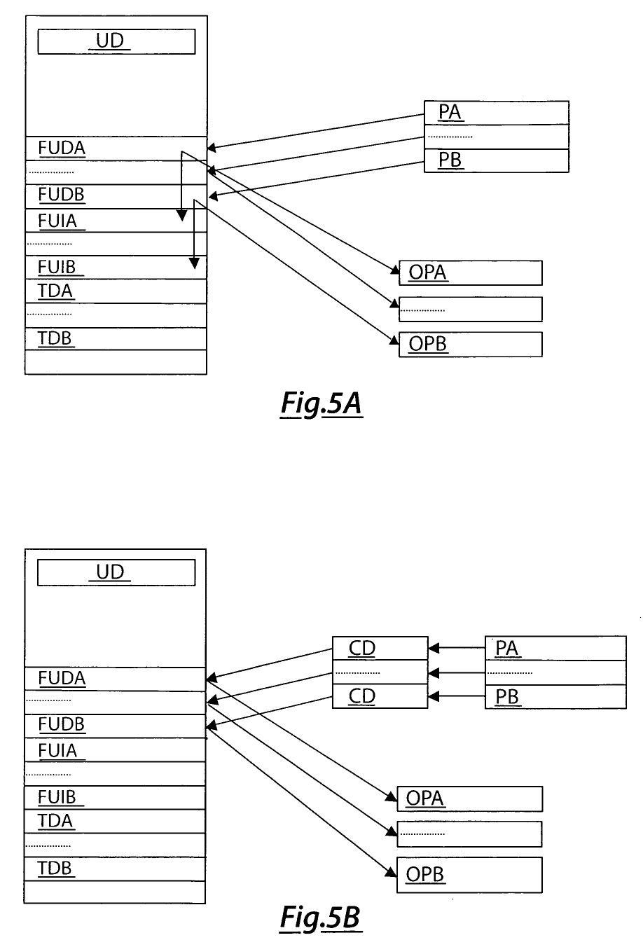

Even the web portal WP1 will put up for sale immediately in its website some goods B or directly the credits; in this case the price paid by the donor user UD will be fully paid into the web portal WP1 (instead of the current account of the shop CN), whereas if the purchase takes place on a partner website part of the cost is paid into the account of the partner website. Additionally, what is purchased and which determines the accumulation of credits, both through Internet and the traditional purchase in shops, can have more than one version (as shown in detail in the appended FIGS. 5A and 5B).

Indeed, if the donor user UD purchases a product PA of version or category of type “a”, credits to which he/she is entitled will go into available user fund FUDA of category “a” and the credits of this fund can be locked up in project objectives OPA falling within the category “a”, as well as if the donor user UD purchases a product DB of category “b”, the credits to which he/she is entitled will go in available user fund FUDB of category “b” and the relative credits can be locked up in project objectives OPB of category “b”.

It is expected that the user can also transfer credits among funds of different categories, but penalizing the donor user UD who carries out the operation, since the latter, during transfer, will lose some credits which will be transferred to a fund F which the managers of the web portal WP1 can use in the manner deemed most appropriate by them.

As previously said, once accumulated the credits, the donor user UD can immediately allot them to projects P which are fundraising.

In order to do this, the donor user UD has at his/her disposal some search tools, such as keywords, categories of membership, percentage already covered by allotted credits, progress report of the project P.

For example, the donor user UD, depending on the state of the project P, can lock up credits (only credits locked up in a project objective OP can always be released) and then these ones pass from the available fund FUD (or FUDA, FUDB, etc., depending on the category of the project objective OP) to the related locked up fund FUI, (or FUIA, FUIB, etc., depending on the category of the project objective OP), or definitively hand them over (in the projects which are already under execution phase), that is transfer directly from the available fund FUD to the donated or allotted total fund TD, TDA, TDB (arrows indicated with 3 and 5 in FIGS. 3 and 4).

When a project P is offered, the donor users UD have the opportunity, at this first phase, to lock up only the credits and receiving user's UR purpose, always in this first phase, is to assure that the donor users UD lock up their credits to cover the total amount (expressed in credits) of the project P.

This is a method necessary to assure that, among the offered projects PP, the project P has the potential to collect all the necessary funds and, therefore, with good probability, constitutes a project with all the resources needed to be carried out.

When the project P is able to get a credits undertaking equal to the total amount, the project P goes to the second phase, i.e. the phase of implementation.

Moreover, during the fundraising phase, the receiving user UR can change the amounts related to single project objectives OP (in case, for example, during this period he/she has had access to other funds from outside sources); In such a case, once sent the request of amount change to the web portal WP1, the profile of the project P with the new amounts expressed in credits of the single project objectives OP will be updated and all the changes will be however visible to the donor user UD.

The receiving user UR has then always the option of “buying” some coupons in the web portal WP1 which give entitlement to a prefixed number of credits (as any user), so that the same receiving user UR can lock up such credits in his/her project.

When the project P passes to execution, an advice is sent to the users who have locked up their credits in the first objective OP of the project P and, starting from this moment, the donor user UD will have a given time interval (decided by the managers of the web portal WP1), during which he/she will still release credits from the objective OP.

Once elapsed this time interval, if all the users who had previously locked up their credits in the first objective OP will not change the destination of their credits, the allotment of money will take place towards receiving user's UR current account CB in order to carry out the first objective OP (arrows indicated with 4 in FIGS. 3 and 4).

On the contrary, if one or more users UA will decide to lock up credits in other projects P, the allotment of money does not start and the receiving user UR (who is now at the implementation phase) will have several options:
purchasing some coupons which will entitle him/her to credits needed to reach the amount for the project P and handing them over to his/her project P, or
waiting that other donor users UD hand over their credits to the project objective OP in question, the project being now in the “execution” phase, or
changing the total amount of credits required by the first objective OP, always sending a request to the web portal WP1, proving, however, to have some alternative resources to finish the project P.

If the receiving user, through one of these options, reaches the amount of credits prefixed, the payment for the first objective OP will occur; such a payment, corresponding to the amount of money associated with the objective OP in question, is that one indicated by the receiving user UR in the initial form TB of the request of publication of the project P.

Once the receiving user has actually carried out the first objective OP of the project P will send a funding request for the second objective OP and, of course, must demonstrate the completion of the first objective OP, thus showing to the donor users UD the proper use of money he has received.

This can happen by publication of documents relating to the project, images, links to other websites, movies and/or contacts, which can prove the occurred completion of the objective OP of the project P; the donor user UD could find all this in the profile of the project P in the web portal WP1.

When the receiving user UR sends a funding request for a second objective OP the same procedure used for the first objective OP is still implemented (advice to the receiving users UR, who still have a prefixed time period to withdraw the credits locked up, money bestowal when achieving the foreseen credits, etc.) and it is so prosecuted until all the objectives OP of the project P are carried out.

Preferably, in the first phase of the method, it is established a certain time period to fundraise for each project P.

This period will be characteristic for each project P (for example, it might depend on the sum which serves to complete the project P) and, once such a time period is elapsed, the project P will be removed and if any receiving user UR still presents some credits locked up in that removed project P the aforesaid credits will be refunded to him/her.

As previously said, two different amounts of credits can be allotted to two projects P that require an equal sum of money to be carried out; this because the formula c=K*Cr: is used, so as to penalize the projects P which have a few objectives OP.

Therefore, if “h” is the number of credits allotted to an objective OP according to the rules of the web portal WP1, the sum paid will not be h*Cr (where Cr is the nominal value of the credits), but, obviously, the sum declared at the beginning by the receiving user UR for that project P (sum that will always be less or at the most equal to the product h*Cr).

In addition, a credit percentage might be refunded to users who have locked up credits in the project P. For example, called x1 the sum of money declared at the beginning in the form of project P presentation by the receiving user UR for a general objective OP of the project P, a part of the credits which may be proportional to

(1−(x1/(h*Cr)))

will be refunded to the donor user UD who has locked up the credits.

This refund serves: to avoid losing the power to finance the projects P to credits of the users who finance projects which do not have a high degree of reliability.

In the restitution it is possible to round down and the fractions of credit arising from the rounding off which will not be given back will be alloted into the reserve fund F of the web portal WP1.

It can be, finally, provided the option to hand over the entire part

(1−(x1/(h*Cr)))*h

to the reserve fund F, in order to discourage the donor users UD to invest in low reliability projects P.

From the description made the technical characteristics of the method for offering the user, through a web portal, a project to be financed by means of credits accumulated with purchases over Internet in properly selected e-commerce sites, which is the object of the present invention, as well as the resulting benefits, are clear.

1. Method for offering the user, through a web portal (WP1), a project (P) to be financed by means of credits accumulated with purchases over Internet in e-commerce sites, characterized in that it comprises the following phases:
access to said-portal or website (WP1) of at least one receiving user (UR) which offers one or more projects (P) to be financed, said offered projects (PP) being associated with one or more objectives (OP);
request, by said receiving user (UR), of the publication on said web portal (WP1) of said project (P) to be financed, with the indication of one or more variables sums of money which can be associated with said one or more objectives (OP);
processing of said request through at least one database server (DS);
publication in the web portal (WP1) of a table (TB) showing said objectives (OP), status (S) of the project (P) and a set of values (V1, V2, . . . , Vn) of a certain amount of credits assigned to respective objectives (OP) through prefixed rules, said project (P) thus being visible to one or more donor users (UD);
accumulation of said amount of credits within a predetermined available user fund (FUD) at the moment of the purchase of at least one good or product (B), on said portal or website (WP1) and/or other partner sites (SP) and/or with real shops, by said donor users (UD), a price (CT) and a defined amount of credits being associate with said good (B);
allotment of at least part of said credits, by said donor user (UD), to one or more projects (P) to be financed.

2. Method as defined in claim 1, characterized in that said phase of allotment of said credits occurs by locking up the credits, which transit from an available user fund (FUD) to a bounded user fund (FUI), or definitively handing over them to projects (P) already running (PFE), transferring them directly from said available user fund (FUD) to a total fund (TD) of amount of handed over money.

3. Method as defined in claim 2, characterized in that, in a first phase of offering (PP) of said project (P), said donor users (UD) can only locking up the credits, in order to cover with said bounded credits the total credits amounts of the entire project (P), before starting financing at least a first objective (OP).

4. Method as defined in claim 1, characterized in that said receiving user (UR) is able to purchase a set of coupons in the web portal (WP1), said coupons being suitable to offer a preset number of credits to be locked up in the offered project (PP) by said receiving user (UR).

5. Method as defined in claim 3, characterized in that, in a second phase of implementation of said project (P), an advice, from which a given time interval within which said donor users (UD) can release the credits from said first objective (OP) starts, is sent to the donor users (UD) who have locked up their credits in at least one first objective (OP) of the project (P).

6. Method as defined in claim 5, characterized in that, once said time interval is elapsed, in case said donor users (UD) have not released said credits from said first objective (PO), the bestowal of money towards said receiving user (UR) will occur for carrying out said first objective (OP).

7. Method as defined in claim 5, characterized in that, once said time interval is elapsed, in case one or more of said donor users (UD) release one or more credits from said first objective (OP) and locks up said one or more credits in other offered projects (PP), the bestowal of money towards the receiving user (UR) does not occur and said receiving user (UR) will have the opportunities to:
buy coupon entitling to credits required for carrying out said first objective (OP) of the project (P) and hand them over to said project (P) and/or
wait that other donor users (UD) hand over their credits to said, first objective (OP) of the project (P) and/or
change the total amount of credits necessary for carrying out said first objective (OP) of the project (P),
in order to obtain the bestowal of money for carrying out said first objective (OP) of the project (P).

8. Method as defined in claim 1, characterized in that said receiving user (UR) is able to send a funding request for at least a second objective (OP) after having really completed a first objective (OP) of the project (P), the completion of said first objective (OP) being shown to said donor users (UD) through publication of documents relating to the project (P) on said web portal (WP1).

9. Method as defined in claim 3, characterized in that said first phase of offering (PP) of the project (P) has a set finished time, beyond which said project (P) is removed and the credits possibly locked up by said receiving user (UR) in one or more objectives (OP) of the project (P) are given back to said receiving user (UR).

10. Method as defined in claim 9, characterized in that a part of the credits proportional to said sum of money indicated by said receiving user (UR) and/or to the number of credits assigned to said one or more objectives (OP) of the project (P) and/or to the nominal value of the credits, is given back to said donor users (UD) who have locked up credits in one or more objectives (OP) of said project (P).

11. Method as defined in claim 9, characterized in that the credits corresponding to said sum of money indicated by said receiving user (UR) are transferred to a reserve fund (F) at said web portal (WP1) managers' disposal.

12. Method as defined in claim 1, characterized in that said purchase phase generates a money flow towards said web portal (WP1) and/or said partner websites (SP) and a virtual flow of credits which increases the amount of credits to be locked up by said receiving user (UR) who has carried out the purchase.

13. Method as defined in claim 1, characterized in that, in case said purchase phase is carried out at a real shop, said receiving user (UR) which makes the purchase receives an identification code (CD), which can be associated with said purchased good (B), which gives the donor user (UD) the possibility of receiving credit related to the purchased good (B) and with which a predefined amount of credits is associated.

14. Method as defined in claim 1, characterized in that said good (B) is put on sale by said web portal (WP1) directly on its own website.

15. Method as defined in claim 1, characterized in that said good (B) has more than one version and/or category and said credits are accumulated into available user funds (FUD) of different versions and/or categories and can be locked up in objectives (OP) which are included in at least one determined version and/or category.

16. Method as defined in claim 15, characterized in that said credits are transferable between available user funds (FUD) of different versions and/or categories and in the transfer one or more credits are transferred to a reserve fund (F) at said web portal (WP1) managers' disposal.

17. Method as defined in claim 1, characterized in that said receiving user (UR) is associated with at least one guarantor user (UG).

18. Method as defined in claim 1, characterized in that said amount of credits for said receiving user (UR) into which said sum of money is converted is a function increasing with the carried out number of projects (P) and decreasing with the non-carried out number of projects (P).

19. Method as defined in claim 18, characterized in that said amount of credit is function of a parameter derived from donor users' (UD) opinion who have locked up or not their credits in the project (P), said parameter being modifiable by the managers of said web portal (WP1).

20. Method as defined in claim 1, characterized in that the number of credits allotted to each objective (OP) of the project (P) depends on the number of objectives (OP) of said project (P).
